(19) United States
(12) Patent Application Publication
(10) Pub. No.: US 2009/0026007 A1
(43) Pub. Date: Jan. 29, 2009

(54) LOUDSPEAKER WITH AN ACOUSTIC MEMBER

(75) Inventor: David Magda Eddy Corynen, Dendermonde (BE)

Correspondence Address: SHEEHAN PHINNEY BASS & GREEN, PA;c/o PETER NIEVES, 1000 ELM STREET, MANCHESTER, NH, 03105-3701, US

(73) Assignee: PSS Belgium N.V.

(21) Appl. No.: 11/575,773

(22) PCT Filed: Sep. 29, 2005
(86) PCT No.: PCT/IB05/53212

§ 371 Date: Mar. 22, 2007

(30) Foreign Application Priority Data
Sep. 30, 2004 (EP) 04104781.2

(51) Int. Cl. H04R 7/04

(52) U.S. Cl. 181/171

(57) ABSTRACT

A large-excursion loudspeaker (20) comprising an acoustic member (10) and a drive unit (21). The acoustic member is intended for operation in piston mode and provided with a plate-like body (1). The drive unit is meant for translating the acoustic member along a translation axis (x) which is oriented substantially perpendicular to a main face of the plate like body. The acoustic member is suspended from a frame (23) by an arrangement of two flexible suspensions (25, 27) which are arranged at an axial distance from each other, seen along said translation axis. For manufacturing reasons the plate-like body comprises a structure of lips (3). The lips substantially extend perpendicular to said main face and are integral portions of the plate-like body. One of the suspensions is a spider-suspension (27) which is attached to the structure of lips.

The invention relates to a loudspeaker comprising an acoustic member intended for operation in piston mode and provided with a plate-like body, a drive unit for translating the acoustic member along a translation axis which is oriented substantially perpendicular to a main face of the plate-like body, and a frame from which the acoustic member is suspended by an arrangement of two flexible suspensions which are arranged at an axial distance from each other, seen along said translation axis.

U.S. Pat. No. 6,095,280 discloses a large-excursion loudspeaker of the moving coil type, which comprises a flat dual-skin diaphragm supported by a frame, a voice coil including a former and a voice coil winding supported by the former, and a system for stabilizing and centering the voice coil in a magnetic gap while it is linearly displaced by an electro-magnetic motor. This system includes a tubular stabilizer which is attached to the diaphragm by means of an impregnated foam or an adaptor ring adhered to the bottom of the diaphragm, a spider-suspension comprising a corrugated suspender attached at one end to the frame and at the other end to the lower end of the tubular stabilizer, and a roll-suspension comprising an arcuate roll attached to the outer peripheral edge of the diaphragm on an inside edge and to the frame on an outside edge.

The system for stabilizing and centering the voice coil of the known loudspeaker is rather manufacture-unfriendly system, and thus expensive.

For this reason it is an object of the invention to provide a loudspeaker which is suitable as large-excursion loudspeaker and which has a manufacture-friendly construction for stabilizing the movements of the acoustic member.

This object is achieved by the loudspeaker according to the invention, which comprises an acoustic member intended for operation in piston mode and provided with a plate-like body, a drive unit for translating the acoustic member along a translation axis which is oriented substantially perpendicular to a main face of the plate-like body, and a frame from which the acoustic member is suspended by an arrangement of two flexible suspensions which are at an axial distance from each other, seen along said translation axis, wherein the plate-like body comprises a structure of lips which lips substantially extend perpendicular to said main face and are integral portions of the plate-like body, and wherein at least one of the suspensions is attached to the structure of lips.

In the loudspeaker according to the invention the structure of lips serves to create each desired axial distance between said two suspensions in order to obtain and maintain stabile movements of the acoustic member, even when extremely large excursions for high-power applications are required. The plate-like body and the structure of lips form a one-piece component which is easy to manufacture. The plate-like body may be a metal sheet, e.g. a sheet of aluminium or magnesium, the lips being parts bent out of the sheet. Alternatively, the plate-like body may be an inject-molded product, particularly a plastic product, and thus provided with integrated lips. Suitable plastics are e.g. acrylonitrile butadiene styrene (ABS), polycarbonate (PC) and polypropylene (PP). Instead of plastics, suitable other materials can be used for manufacturing the plate-like body by inject moulding. All the possible variants of the plate-like body as applied in the loudspeaker according to the invention can be quantity-produced by known machines for low production costs. Moreover, the assembly of the plate-like body, particularly its structure of lips and the suspension(s) can take place in a simple automatized way. Apart from the above described advantage relating to the manufacture of the loudspeaker, the loudspeaker according to the invention has the further advantage that the applied construction provides freedom in choosing its design without limiting its technical characteristics. Particularly, the depth of the loudspeaker can be taken very small in spite of a required large excursion of the acoustic member.

It is preferred to provide the plate-like body with a structure of ribs for reinforcing the body. Preferably these ribs substantially extend parallel to a main face of the plate-like body and are integral portions thereof. For design reasons it is favourable to orient the ribs at least partly corresponding to the contours of the acoustic members. The ribs may be integral parts of the plate-like body. When the plate-like body is a metal sheet, the ribs may be portions bent out of or pushed through from the plate-like body.

In a practical embodiment of the loudspeaker according to the invention the acoustic member is provided with a membrane extending parallel to the plate-like body, a main face of the membrane being attached to a main face of the plate-like body. The membrane can be made of any suitable material, such as metal, plastic, glass or paper.

It is to be noted that JP-A 57-2193 discloses a rectangular speaker diaphragm which has a sandwich structure and is provided with two reinforcement beams adhered to a main surface of the diaphragm and extending in the length direction of the diaphragm.

It is further to be noted that U.S. Pat. No. 4,928,312 discloses a planar ceiling speaker panel having a periphery portion of an expanded polystyrene foam and a diaphragm portion of foamed polymer suspended resiliently from the periphery portion. The diaphragm has a plurality of radially expanding ribs for stiffering the diaphragm.

Both the known rectangular speaker diaphragm and the known planer ceiling speaker panel only has an oblique relationship with the loudspeaker according to the invention.

In a practical embodiment of the loudspeaker according to the invention the drive unit comprises a stationary drive section secured to the frame and a translatable drive section secured to the plate-like body. The drive unit may be of the well-known electro-magnetic type, i.e. the translatable drive section is provided with an energizing coil and the stationary part is provided with a permanent magnet, or vice versa. In this embodiment the lips are preferably positioned in a zone extending around the translatable drive section.

In a further practical embodiment of the loudspeaker according to the invention one of the suspensions is a spider-suspension, which may be of a known type and which is adhered to the lips near its inner circumferential edge and fixed to the frame near its outer circumferential edge. The other suspensions is preferably a roll-suspension which may be of a known type and which is fixed to the plate-like body near its inner circumferential edge and fixed to the frame near its outer circumferential edge.

The loudspeaker according to the invention is suitable for sound reproduction in TV-, hifi-, home-, automotive- and multimedia-audio systems and is particularly meant for high-power audio systems.

The invention also relates to a plate-like body which presents features of the plate-like body disclosed in this paper and which is constructed and evidently intended for use in the loudspeaker according to the invention.

The invention further relates to an acoustic member including or existing of the plate-like body according to the invention. Preferably, the acoustic member according to the invention is provided with a membrane extending parallel to the plate-like body.

With regards to the claims it is noted that various combinations of embodiments and features as disclosed in the claims are possible and/or intended within the scope of the invention. These combinations are part of the invention.

The invention will now be described in more detail, by way of example, with reference to the drawings, in which

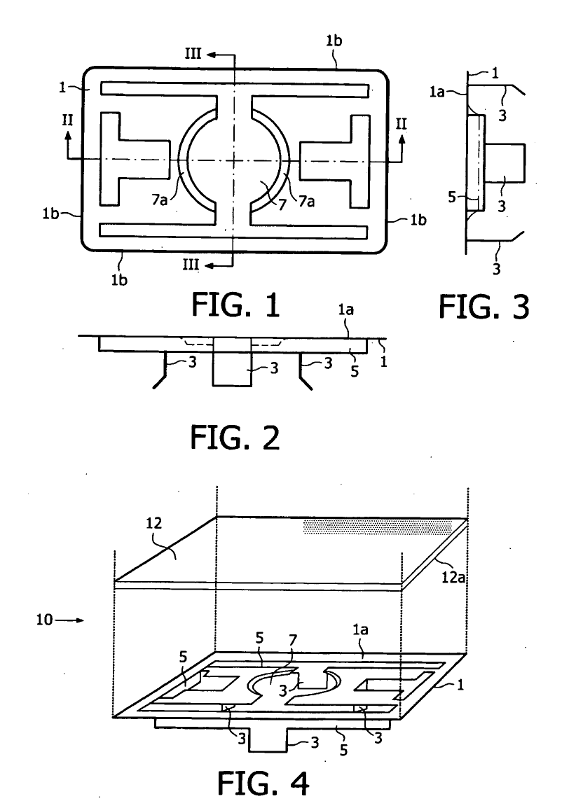

FIG. 1 is a diagrammatical top view of an embodiment of the plate-like body according to the invention,

FIG. 2 is a diagrammatical cross-section II-II of the embodiment of FIG. 1,

FIG. 3 is a diagrammatical cross-section III-III of the embodiment of FIG. 1,

FIG. 4 diagrammatically shows in an exploded view an embodiment of the acoustic member according to the invention,

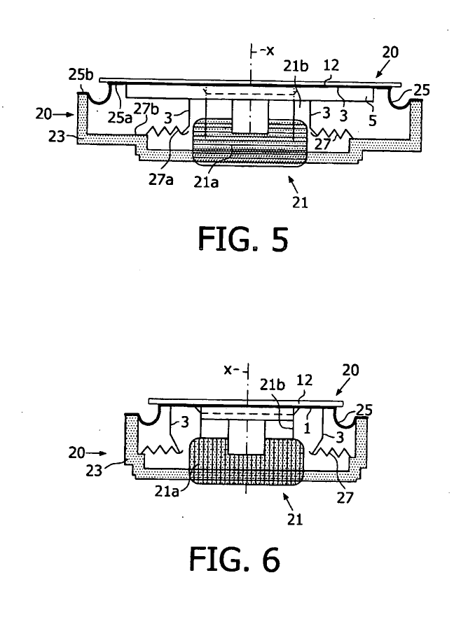

FIG. 5 shows diagrammatically in a cross-section corresponding to the cross-section II-II in FIG. 1 an embodiment of the loudspeaker according to the invention, and

FIG. 6 shows diagrammatically in a cross-section corresponding to the cross-section III-III in FIG. 1 the embodiment shown in FIG. 5.

The plate-like body 1 depicted in the FIGS. 1 to 3 is in principle a sheet provided with a structure of lips 3 and a structure of ribs 5. In this embodiment the sheet is made of aluminium and further provided with a central opening 7. The lips 3, ribs 5 and the opening 7 may be formed by mechanical methods or processes known per se, such as punching, cutting and/or bending. When the plate-like body 1 is an inject-moulded product the structure of lips and the structure of ribs and optionally the central opening may be formed during the moulding process.

The depicted plate-like body 1 has four lips 3 which are regularly situated around the central opening 7 and are oriented perpendicular to a main face 1a of the plate-like body 1. The lips 3 serve for mounting a suspension discussed hereinafter.

The depicted plate-like body 1 further has four ribs 5 which extend parallel to the main face 1a of the plate-like body 1 and are mainly oriented along the contours 1b of the plate-like body 1. The ribs 5 serve for reinforcing the plate-like body 1.

The acoustic member 10 depicted in FIG. 4 is composed of the plate-like body 1 and a membrane 12 which extends parallel to the plate-like body 1. The membrane 12 is made of a suitable membrane material known per se; in this embodiment the material is plastic, particularly polycarbonate (PC). Another suitable material is polymethylmethacrylate (PMMA). A main face 12a of the membrane 12 is attached, in this embodiment by means of a glue, to the main face 1a of the plate-like body 1. The acoustic member 10 manufactured in a way as indicated above has a desired stiffness and has excellent characteristics for operation in piston mode, due to the fact that the properties of the plate-like body 1 and the member 12 can be chosen independently from each other.

The loudspeaker 20 depicted in the FIGS. 5 and 6 comprises the acoustic member 10, a drive unit 21 for driving the acoustic member 10 along a translation axis x, and a frame 23 for suspending the acoustic member 10 and supporting the drive unit 21. The drive unit 21 consists of a stationary drive section 21a secured to the frame 23 and a translatable drive section 21b secured to the plate-like body 1 of the acoustic member 10. The stationary drive section 21a comprises a magnet system having a permanent magnet and a magnetic yoke forming an air gap. The translatable drive section 21b comprises a coil system having a coil support and a voice coil extending in said air gap. Such a drive unit is generally known and for this reason it is not further explained in this paper. Alternatively, the stationary drive section may comprise the coil system and the translatable drive section may comprise the magnet system.

The translatable drive section 21b, which is co-axial with the central opening 7 of the plate-like body 1, is attached in this embodiment by means of an adhesive to two curved collar segments 7a which partly surround the opening 7. A suitable adhesive is e.g. a two-component glue known per se.

The loudspeaker 20 is provided with a suspension system having two flexible suspensions 25 and 27. The suspension 25 is a so-called roll-suspension having a ring-shaped arruate roll known per se and made of e.g. rubber or foam. Its inner circumferential edge 25a is fixed to the plate-like body 1, while its outer circumferential edge 25b is fixed to the frame 23. The suspension 27 is a so-called spider-suspension having a ring-shaped corrugated body known per se and made of e.g. textile. Its inner circumferential edge 27a is fixed to the lips 3 and its outer circumferential edge 27b is fixed to the frame 23. All these fixations may be realized by making use of a suitable glue, such as the above specified adhesive.

It is to be noted that it is possible within the scope of the invention to vary from the depicted embodiments. It is e.g. within the scope to apply a circular plate-like body or a plate-like body with a rectangular central opening.

1. A loudspeaker comprising
an acoustic member intended for operation in piston mode and provided with a plate-like body,
a drive unit for translating the acoustic member along a translation axis which is oriented substantially perpendicular to a main face of the plate-like body, and
a frame from which the acoustic member is suspended by an arrangement of two flexible suspensions which are at an axial distance from each other, seen along said translation axis, wherein the plate-like body comprises a structure of lips which lips substantially extend perpendicular to said main face and are integral portions of the plate-like body, at least one of the suspensions being attached to the structure of lips.

2. A loudspeaker as claimed in claim 1, wherein the plate-like body comprises a structure of ribs for reinforcing, which ribs substantially extend parallel to said main face and are integral portions of the plate-like body.

3. A loudspeaker as claimed in claim 1 or 2, wherein the acoustic member is provided with a membrane extending parallel to the plate-like body, a main face of the membrane being attached to said main face of the plate-like body.

4. A loudspeaker as claimed in claim 1, 2 or 3, wherein the plate-like body is a metal sheet, the lips being parts bent out of the sheet.

5. A loudspeaker as claimed in claim 2, wherein the ribs are at least partly oriented corresponding to the contours of the acoustic member.

6. A loudspeaker as claimed in claim 2, wherein the plate-like body is a metal sheet, the ribs being portions bent out of or pushed through from the sheet.

7. A loudspeaker claimed in claim 1, 2 or 3, wherein the drive unit comprises a stationary drive section secured to the frame and a translatable drive section secured to the plate-like body, the lips being positioned in a zone extending around the translatable drive section.

8. A loudspeaker as claimed in claim 1, 2 or 3, wherein one of the suspensions is a spider-suspension which is adhered to the lips near its inner circumferential edge and fixed to the frame near its outer circumferential edge.

9. A loudspeaker as claimed in claim 8, wherein the other suspension is a roll-suspension which is fixed to the plate-like body near its inner circumferential edge and fixed to the frame near its outer circumferential edge.

10. A loudspeaker as claimed in claim 1, 2 or 3, wherein the plate-like body is made of aluminum or magnesium.

11. A loudspeaker as claimed in claim 1, 2 or 3, wherein the plate-like body is an inject-molded product.

12. A loudspeaker as claimed in claim 2, wherein the membrane is made of metal, plastic, glass or paper.

13. A plate-like body presenting all the features of the plate-like body disclosed in any one of the preceding claims and being thus constructed and evidently intended for use in the loudspeaker as claimed in any one of the preceding claims.

14. An acoustic member provided with the plate-like body as claimed in claim 13.

15. An acoustic member as claimed in claim 14, provided with a membrane which extends parallel to the plate-like body.
